(19) United States
(12) Patent Application Publication
(10) Pub. No.: US 2025/0249624 A1
(43) Pub. Date: Aug. 7, 2025

(54) Systems and Methods for the Compressing of Graphite

(71) Applicant: Matthews International GmbH, Vreden (DE)

(72) Inventor: Frank BOGENSTAHL, Ahaus (DE)

(21) Appl. No.: 19/187,031

(22) Filed: Apr. 23, 2025

Related U.S. Application Data
(63) Continuation-in-part of application No. 18/753,417, filed on Jun. 25, 2024.
Application No. 18/753,417 is a continuation of application No. PCT/EP2024/066665, filed on Jun. 14, 2024.
(60) Provisional application No. 63/521,265, filed on Jun. 15, 2023.

(51) Int. Cl. B29C 43/22; B29C 43/00; B29C 43/34; B29C 43/46; B29C 43/52; C01B 32/20

(52) U.S. Cl. CPC B29C 43/222; B29C 43/003; B29C 43/34; B29C 43/46; B29C 43/52; C01B 32/20; B29C 2043/3427; B29C 2043/463; B29C 2043/467

(57) ABSTRACT

Systems and methods are described for the compression of graphite flakes to form a continuous graphite web. An example of such a system includes at least one hopper to provide graphite flakes and a set of rollers configured to compress the graphite flakes into a graphite web.

### CROSS-REFERENCE TO RELATED APPLICATIONS

The present application is a continuation-in-part of U.S. patent application Ser. No. 18/753,417, filed Jun. 25, 2024, which is a continuation application of International Patent Application No. PCT/EP2024/066665, filed Jun. 14, 2024, which claims priority to U.S. Provisional Application No. 63/521,265, filed Jun. 15, 2023, all of which are incorporated herein by reference in their entireties.

### BACKGROUND

Fuel cells are electrochemical devices that can do work when electrochemically combining oxygen and hydrogen to generate electricity. The generated electricity can be used in any application that requires power to do work such as light, medium, and heavy duty motive power; fork lift operation; back-up generators; and stationary power as examples. A significant fuel cell component is the bi-polar plate that has the following functions: direct fluids down channels; allow the diffusion of gases in channels to the fuel cell electrodes; facilitate current flowing from the anode to cathode side of the cell; direct coolant along a multitude of channels; allow for heat transfer from exothermic cathode reaction to the coolant stream to ensure desired thermal gradient is achieved; and to effectively minimize or prevent leak pathways for one gas to leak to another gas or for any of the gas to leak to the coolant.

During the embossing of graphite based bipolar plates, the graphite is compressed from a flake-based material. This flake material contains a large amount of air, which is removed during the process. Current standard embossing processes traps the air inside of the material and prevents the air flow out of the material. This leads to air bubbles inside of the compressed material which makes the material not appropriately suited for further production steps. It has been previously shown that after the removal of air from the graphite flakes the material is easy to compress and can be embossed in a standard embossing unit. Currently, the compressing is done in a flatbed press process and has to be repeated several times to complete the removal of the air from the graphite flakes. Furthermore, methods used in the prior art, in particular flatbed press processes do not correctly form desired and/or wanted structures. The currently process is designed for use on graphite sheets, and therefore is not suited for mass production in a roll-to-roll process.

Embossing is a frequently utilized step in the processing of graphite materials into bipolar plates. Different embossing depths may require different basis weights to ensure consistent porosity and density within the graphite materials. Therefore, there exists a need for improved compressing of graphite flakes into a web with appropriate basis weight and density distribution to ensure that the regions being embossed have appropriate structural integrity.

### SUMMARY

In one embodiment, the techniques described herein relate to a system for compressing graphite, the system including: at least one hopper configured to supply graphite; a first guide roller; a second guide roller; a first nip roller; a second nip roller; a first belt attached to the first guide roller and the first nip roller; and a second belt attached to the second guide roller and the second nip roller; wherein; the first belt and the second belt are configured to direct graphite to the first nip roller and the second nip roller, and the first nip roller and the second nip roller are configured to compress graphite as the graphite passes between the first nip roller and the second nip roller.

In one embodiment, the techniques described herein relate to a system for compressing graphite, the system including: at least one feeder element or hopper, wherein the feeder element or hopper is compartmentalized to allow for targeted deposition of graphite.

In one embodiment, the techniques described herein relate to a method of compressing graphite, the method including: providing a system, wherein the system includes at least one hopper, a first guide roller, a second guide roller, a first nip roller, a second nip roller, a first belt attached to the first guide roller and the first nip roller, and a second belt attached to the second guide roller and the second nip roller; providing graphite into the at least one hopper; inserting the graphite between the first guide roller and the second guide roller using the at least one hopper; guiding the graphite towards the first nip roller and second nip roller using the first belt and the second belt; and compressing the graphite using the first nip roller and the second nip roller.

In one embodiment, the techniques described herein relate to a system for compressing graphite, the system including: at least one hopper configured to supply graphite; and a first barrel roller and a second barrel roller configured to compress graphite as the graphite passes between the first barrel roller and the second barrel roller.

In one embodiment, the techniques described herein relate to a method for compressing graphite, the method including: providing a system, wherein the system includes at least one hopper, a first barrel roller, and a second barrel roller; providing graphite into the at least one hopper; inserting the graphite between the first barrel roller and the second barrel roller using the at least one hopper; and compressing the graphite using the first barrel roller and the second barrel roller.

In one embodiment, the techniques described herein relate to a processed graphite web, wherein the processed graphite web is produced by: providing a system, wherein the system includes at least one hopper, a first guide roller, a second guide roller, a first nip roller, a second nip roller, a first belt attached to the first guide roller and the first nip roller, and a second belt attached to the second guide roller and the second nip roller; providing graphite into the at least one hopper; inserting the graphite between the first guide roller and the second guide roller using the at least one hopper; guiding the graphite towards the first nip roller and second nip roller using the first belt and the second belt; and compressing the graphite using the first nip roller and the second nip roller.

In one embodiment, the techniques described herein relate to a processed graphite web, wherein the processed graphite web is produced by: providing a system, wherein the system includes at least one hopper, a first barrel roller, and a second barrel roller; providing graphite into the at least one hopper; inserting the graphite between the first barrel roller and the second barrel roller using the at least one hopper; and compressing the graphite using the first barrel roller and the second barrel roller.

In one embodiment, the techniques described herein relate to a system for compressing graphite, the system comprising: at least one feeder element and/or hopper configured to supply graphite; and a first roller and a second roller configured to compress graphite as the graphite passes between the first roller and the second roller.

It is possible that the first roller and the second roller are configured to pre-compact the graphite.

It is possible that the first roller and the second roller are configured to emboss the graphite.

It is possible that the first roller comprises a first barrel roller and/or is configured as a first barrel roller and the second roller comprises a second barrel roller and/or is configured as a second barrel roller.

It is possible that the first roller, optionally the first barrel roller, has a surface which has a flow field geometry.

It is possible that the second roller, optionally the second barrel roller, has a surface which has a flow field geometry.

It is possible that the first roller, optionally the first barrel roller, and/or the second roller, optionally the second barrel roller, optionally each, have a surface, and the surface and-/or the surfaces of the roller(s), optionally the barrel roller(s), is/are porous and/or the surfaces have different friction coefficients and/or roughness coefficients and/or the first roller, optionally the first barrel roller, and/or the second roller, optionally the second barrel roller, have different rotational speeds and/or the have different surface velocities.

It is possible that the surface roughness of at least one roller is adjusted to adjust a basis weight of the compressed graphite.

It is possible that the distance between the first roller, optionally the first barrel roller, and the second roller, optionally the second barrel roller, is adjustable and/or is about 0.3 mm to about 5 mm, optionally of about 0.4 mm to about 4 mm, optionally of about 0.5 mm to about 3 mm, optionally about 0.6 mm to about 2.0 mm, and/or optionally about 1.0 mm to about 1.5 mm, and/or the feeder element and/or hopper is configured to adjust a height of a level at which the graphite gets into first contact with the first roller and/or the second roller.

It is possible that the system further comprises at least one vacuum pump, wherein the vacuum pump is configured to create a vacuum around the roller, optionally the first barrel roller, and/or the second roller, optionally the second barrel roller.

It is possible that that the system, optionally the feeder element, further comprises a first belt and a second belt being configured to direct the graphite, optionally from the hopper, to the first roller and the second roller.

It is possible that the system further comprises a first guide roller; and a second guide roller, wherein the first belt is attached to the first guide roller and the first roller; and the second belt is attached to the second guide roller and the second roller.

It is possible that the first roller comprises at least one nip roller and/or the second roller comprises at least one second nip roller.

It is possible that the first belt and/or the second belt have/has a surface which has a flow field pattern.

It is possible that the first belt and/or the second belt is/are porous.

It is possible that the system comprises a plurality of first rollers and second rollers, wherein optionally at least two rollers have surfaces with different friction coefficients and/or roughness coefficients and/or optionally at least two rollers have different rotational speeds and/or have different surface velocities.

It is possible that the system further comprises at least one further feeder element, optionally comprising at least one additionally hopper, configured to supply graphite to at least one second first roller and at least one second second roller.

It is possible that the further feeder is configured to supply graphite depending on a thickness and/or basis weight of compressed graphite, in particular graphite web, exiting the first roller and second roller, optionally the further feeder is controlled based on signals of a first sensing element measuring a thickness and/or basis weight of compressed graphite exiting the first roller and the second roller.

It is possible that the further feeder comprises a compartmentalized design, wherein the compartments are configured to allow for targeted deposition or omission of graphite onto the graphite web resulting in density variations across the width of the graphite web.

It is possible that the system further comprises multiple embossing rollers, wherein the embossing rollers are configured to, optionally further, emboss the graphite after the graphite is compressed and/or pre-compacted.

It is possible that the first roller and/or the second roller and/or at least one of the pluralities of first rollers and/or at least one of the plurality of second rollers comprises at least one embossing roller and/or act as at least one embossing roller.

It is possible that the diameter of at least one of the plurality of rollers is adjusted to adjust a basis weight and density of the compressed graphite.

In one embodiment, the techniques described herein relate to a method for compressing graphite, the method comprising: providing a system, wherein the system comprises at least one feeder element and/or hopper, a first roller, and a second roller; providing graphite into the at least one feeder element and/or hopper; inserting the graphite between the first roller and the second roller using the at least one feeder element and/or hopper; and compressing the graphite using the first roller and the second roller.

It is possible that compressing the graphite comprises pre-compacting the graphite.

It is possible that compressing the graphite comprises embossing the graphite.

It is possible that the first roller comprises a first barrel roller and/or is configured as a first barrel roller and/or the second roller comprises a second barrel roller and/or is configured as a second barrel roller, wherein the first barrel roller has a surface which has a flow field geometry, and/or the second barrel roller has a surface which has a flow field geometry.

It is possible that the first roller, optionally the first barrel roller, and the second roller, optionally the second barrel roller, optionally each, has/have a surface, and the surface and/or the surfaces of the roller(s), optionally the barrel roller(s) is/are porous and/or the surfaces have different friction coefficients and/or roughness coefficients and/or roughness coefficients and/or the first roller, optionally the first barrel roller, and/or the second roller, optionally the second barrel roller, have different rotational speeds and/or the have different surface velocities.

It is possible that the distance between the first roller, optionally the first barrel roller, and the second roller, optionally the second barrel roller, is adjustable and/or is about 0.3 mm to about 5 mm, of about 0.4 mm to about 4 mm, of about 0.5 mm to about 3 mm, optionally about 0.6 mm to about 2.0 mm, and/or optionally about 1.0 mm to about 1.5 mm, and/or the feeder element and/or hopper is adjusted to change a height of a level at which the graphite gets into first contact with the first roller and/or the second roller.

It is possible that the method further comprises providing at least one vacuum pump; and creating a vacuum around the first roller, optionally the first barrel roller, and/or the second roller, optionally the second barrel roller.

It is possible that the method further comprises providing, optionally as part of the feeder element, a first belt and a second belt being configured to direct the graphite, optionally from the hopper, to the first roller and the second roller.

It is possible that the method further comprises providing a first guide roller; and a second guide roller, and connecting the first belt to the first guide roller and the first roller; and connecting the second belt to the second guide roller and the second roller.

It is possible that the method further comprises providing a plurality of first rollers and second rollers wherein optionally at least two rollers have surfaces with different friction coefficients and/or roughness coefficients and/or optionally at least two rollers have different rotational speeds and/or have different surface velocities.

It is possible that the method further comprises providing at least one further feeder element, optionally comprising at least one additionally hopper, configured to supply graphite to at least one second first roller and at least one second second roller.

It is possible that the method further comprises changing, regulating and/controlling a supply of graphite by the further feeding element depending on a thickness of basis weight of compressed graphite exiting the first roller and second roller, optionally controlling the further feeder based on signals of a first sensing element measuring a thickness and/or basis weight of compressed graphite exiting the first roller and the second roller.

It is possible that the method further comprises providing multiple embossing rollers; and, optionally further, embossing the graphite after the graphite is compressed and/or pre-compacted.

In one embodiment, the techniques described herein relate to a processed graphite web, wherein the processed graphite web is produced by: providing a system, wherein the system comprises at least one feeder element and/or hopper, a first roller, and a second roller; providing graphite into the at least one feeder element and/or hopper; inserting the graphite between the first roller and the second roller using the at least one feeder element and/or hopper; and compressing the graphite using the first roller and the second roller.

It is possible that compressing the graphite comprises pre-compacting the graphite.

It is possible that compressing the graphite comprises embossing the graphite.

It is possible that the first roller comprises a first barrel roller and/or is configured as a first barrel roller and/or the second roller comprises a second barrel roller and/or is configured as a second barrel roller.

It is possible that the processed graphite web has a uniform density.

It is possible that the processed graphite web has a density of about 0.05 g/cc to about 2.5 g/cc, about 0.50 g/cc to about 2.00 g/cc, of about 1.00 g/cc to about 1.80 g/cc, and/or of about 1.50 g/cc to about 1.75 g/cc. In some embodiment typically basis weights of 30 mg/sc to 80 mg/sc are used that lead to a density of 0.05 g/cc to 0.8 g/cc of a graphite web with a thickness of 1 mm to 5 mm.

It is possible that the processed graphite web has a thickness of about 0.3 mm to about 5 mm, of about 0.4 mm to about 4 mm, of about 0.5 mm to about 3 mm, of about 0.6 mm to about 2.0 mm, and/or of about 1.0 mm to about 1.5 mm.

It is possible that the production of the processed graphite web further comprises: providing at least one vacuum pump; and creating a vacuum around the first roller, optionally the first barrel roller, and/or the second roller, optionally the second barrel roller.

It is possible that the production of the processed graphite web further comprises: providing, optionally as part of the feeder element, a first belt and a second belt being configured to direct the graphite, optionally from the hopper, to the first roller and the second roller.

It is possible that the production of the processed graphite web further comprises providing a first guide roller; and a second guide roller, and connecting the first belt to the first guide roller and the first roller; and connecting the second belt to the second guide roller and the second roller.

It is possible that the production of the processed graphite web further comprises providing a plurality of first rollers and second rollers, wherein optionally at least two rollers have surfaces with different friction coefficients and/or roughness coefficients and/or optionally at least two rollers have different rotational speeds and/or have different surface velocities.

It is possible that the production of the processed graphite web further comprises providing at least one further feeder element, optionally comprising at least one additionally hopper, configured to supply graphite to at least one second first roller and at least one second second roller.

It is possible that the production of the processed graphite web further comprises changing, regulating and/controlling a supply of graphite by the further feeding element depending on a thickness of basis weight of compressed graphite exiting the first roller and second roller, optionally controlling the further feeder based on signals of a first sensing element measuring a thickness and/or basis weight of compressed graphite exiting the first roller and the second roller.

It is possible that the production of the processed graphite web further comprises providing multiple embossing rollers; and, optionally further, embossing the graphite after the graphite is compressed and/or pre-compacted.

### BRIEF DESCRIPTION OF THE DRAWINGS

FIG. 1 depicts an illustrative system for compressing graphite using a belt system in accordance with an embodiment.

FIG. 2 depicts an illustrative system for compressing graphite using a belt system in accordance with an embodiment.

FIG. 3 depicts an illustrative system for compressing graphite using a belt system in accordance with an embodiment.

FIG. 4 depicts an illustrative system for compressing graphite using a barrel roller system in accordance with an embodiment.

FIG. 5 depicts an illustrative system for compressing graphite using a barrel roller system in accordance with an embodiment.

FIG. 6 depicts a diagram of a method of compressing graphite in accordance with an embodiment.

FIG. 7 depicts a diagram of a method of compressing graphite in accordance with an embodiment.

FIG. 8a and FIG. 8b depict two illustrative systems for compressing graphite using different configurations of a feeder element and/or hopper.

FIG. 9 depicts an illustrative system for compressing graphite using a multi roller system in accordance with an embodiment.

FIG. 10 depicts an illustrative system for compressing graphite using a multi roller system in accordance with an embodiment.

### DEFINITIONS

As used herein, the term “about” when immediately preceding a numerical value means a range of plus or minus 10% of that value, for example, “about 50” means 45 to 55, “about 25,000” means 22,500 to 27,500, etc., unless the context of the disclosure indicates otherwise, or is inconsistent with such an interpretation.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can, of course, vary. It is also to be understood that the terminology used herein is for the purpose of describing particular embodiments only and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those skilled in the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As used herein “cc” is used as abbreviation for “cubic centimeter” or “cm\hat{ }3” and “sc” is used as abbreviation for “square centimeter” or “cm\hat{ }2”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

### DETAILED DESCRIPTION

This disclosure is not limited to the particular systems, devices and methods described, as these may vary. The terminology used in the description is for the purpose of describing the particular versions or embodiments only and is not intended to limit the scope.

### Systems

Systems can be assembled to aid in the pre-compacting, compressing and/or embossing of graphite to create a graphite web. In some embodiments the system comprises at least one feeder element and/or hopper configured to supply graphite; and a first roller and a second roller configured to compress graphite as the graphite passes between the first roller and the second roller. Optionally the first roller and the second roller are configured to pre-compact the graphite and/or to emboss the graphite. In some embodiments, the system comprises multiple guide rollers, multiple belts, multiple nip rollers configured to compress the graphite, and at least one hopper and/or feeder element to provide the graphite. In some embodiments, the system further comprises multiple embossing rollers. The system is configured to compress graphite flakes into a continuous graphite web with a homogenous density, homogenous basis weight, and or homogenous thickness throughout the continuous graphite web.

In some embodiments, the system is configured to compress the graphite flakes into a continuous graphite web with a non-uniform basis distribution across the web because different embossing depths require different basis weights to ensure consistent porosity and density in the embossed product. In some embodiments, the system comprises multiple barrel rollers configured to compress the graphite and at least one hopper and/or feeder element configured to provide the graphite. In some embodiments, the system further comprises at least one vacuum pump configured to create a vacuum around the graphite during compression. In some embodiments, the system further comprises one or more of at least one cutting unit, at least one impregnation unit, and at least one quality check unit.

FIG. 1 illustrates a system with a feeder element and/or hopper 107 configured to supply graphite, a first guide roller 101 and a second guide roller 102, a first nip roller 103 and a second nip roller 104, a first belt 105 attached to the first guide roller 101 and the first nip roller 103 and a second belt 106 attached to the second guide roller 102 and the second nip roller 104. In some embodiments, the first belt 105 and second belt 106 are configured to direct graphite from the first guide roller 101 and the second guide roller 102 to the first nip roller 103 and the second nip roller 104. In some embodiments, the first nip roller 103 and the second nip roller 104 are configured to compress the graphite as the graphite passes between the first nip roller 103 and the second nip roller 104. In some embodiments, the system further comprises at least one winding unit 108 configured to wind the graphite into a roll after the graphite is compressed.

In some embodiments, the distance between the first nip roller 103 and the second nip roller 104 can be adjusted as desired to control the thickness of the graphite web. In some embodiments, the distance between the first nip roller 103 and the second nip roller 104 is about 0.30 mm, about 0.35 mm, about 0.40 mm, about 0.45 mm, about 0.50 mm, about 0.55 mm, about 0.60 mm, about 0.65 mm, about 0.70 mm, about 0.75 mm, about 0.80 mm, about 0.85 mm, about 0.90 mm, about 0.95 mm, about 1.0 mm, about 1.1 mm, about 1.2 mm, about 1.3 mm, about 1.4 mm, about 1.5 mm, about 1.6 mm, about 1.7 mm, about 1.8 mm, about 1.9 mm, about 2.0 mm, about 2.1 mm, about 2.2 mm, about 2.3 mm, about 2.4 mm, about 2.5 mm, about 2.6 mm, about 2.7 mm, about 2.8 mm, about 2.9 mm, about 3.0 mm, or any range between any two of these values. In some embodiments, the distance between the first nip roller 103 and the second nip roller 104 is about 0.3 mm to about 3.0 mm, about 0.6 mm to about 2.0 mm, or about 1.0 mm to about 1.5 mm.

In some embodiments, at least one or both of the first belt 105 and the second belt 106 have a surface which has a flow field pattern. The flow field pattern can correspond to a flow field pattern of a bipolar plate. In some embodiments, the flow field pattern is imprinted on the graphite as the graphite passes between the first nip roller 103 and the second nip roller 104. In some embodiments, at least one or both of the first belt 105 and the second belt 106 is porous. In some embodiments, the graphite comprises graphite flakes, and each of the pores in the first belt 105 and the second belt 106 is smaller than the size of the graphite flakes. In some embodiments, at least one of the first belt 105 and the second belt 106 is comprised of a screen. The porous belts 105/106 allow for air present in the graphite to be removed from the graphite during compression, as is preferred in the production of bipolar plates.

In some embodiments, at least one or both of the first nip roller 103 and the second nip roller 104 is a structured roller. In some embodiments, the structured roller has a textured surface. In some embodiments, the textured surface has a pattern which comprises features present in the flow field pattern of at least one or both of the first belt 105 and the second belt 106. In some embodiments, the textured pattern is configured to allow the structured roller to interlock with the first belt 105 or the second belt 106. The textured surface allows the structured roller to improve the transport of the first belt 105 and the second belt 106 which increases the stability of the embossing in comparison to unstructured rollers.

In some embodiments, the system further comprises at least one vacuum pump configured to create a vacuum around the first belt 105 and the second belt 106. The vacuum is configured to assist in the removal of air from the graphite during the production of the graphite web. In some embodiments, the vacuum pump is configured to create a vacuum of about 0.10 mbar, about 0.15 mbar, about 0.20 mbar, about 0.25 mbar, about 0.30 mbar, about 0.35 mbar, about 0.40 mbar, about 0.45 mbar, about 0.50 mbar, about 0.55 mbar, about 0.60 mbar, about 0.65 mbar, about 0.70 mbar, about 0.75 mbar, about 0.80 mbar, about 0.85 mbar, about 0.90 mbar, about 0.95 mbar, about 1.00 mbar, about 2 mbar, about 3 mbar, about 4 mbar, about 5 mbar, about 6 mbar, about 7 mbar, about 8 mbar, about 9 mbar, about 10 mbar, about 15 mbar, about 20 mbar, about 25 mbar, about 30 mbar, about 35 mbar, about 40 mbar, about 45 mbar, about 50 mbar, about 55 mbar, about 60 mbar, about 65 mbar, about 70 mbar, about 75 mbar, about 80 mbar, about 85 mbar, about 90 mbar, about 95 mbar, about 100 mbar, about 150 mbar, about 200 mbar, about 250 mbar, about 300 mbar, about 350 mbar, about 400 mbar, about 450 mbar, about 500 mbar, about 550 mbar, about 600 mbar, about 650 mbar, about 700 mbar, about 750 mbar, about 800 mbar, about 850 mbar, about 900 mbar, about 950 mbar, about 1000 mbar, or any range between any two of these values.

The system of FIG. 1 allows a pre-compacting of the graphite with direct embossing. In some embodiments the belts 105, 106 acts as a structured (pre-)compression and/or (pre-)compacting belt. In some embodiments the nip roller 103, 104 act as embossing roller. In some embodiments the combination of the belts 105, 106 and the nip roller 103, 104 act as embossing element(s). In some embodiments the structured graphite web is rolled onto the winding unit 108. In some embodiments the structured graphite web represents graphite based bipolar plates. In some embodiments the system of FIG. 1 represents an embossing belt calender.

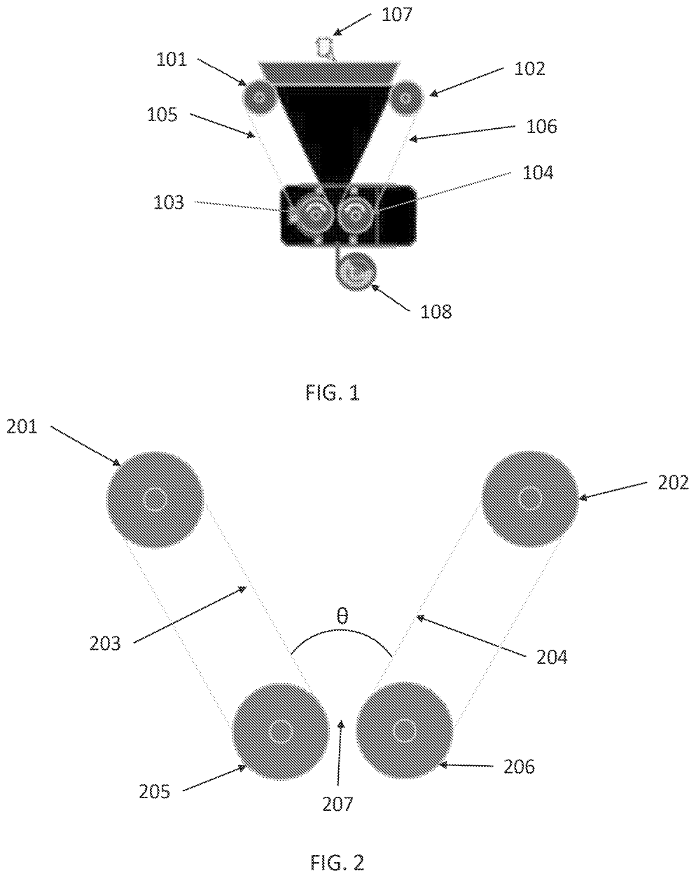

FIG. 2 illustrates a system with a first guide roller 201, a second guide roller 202, a first belt 203, and a second belt 204. In some embodiments, the distance between the first guide roller 201 and the second guide roller 202 can be adjusted. In some embodiments, adjusting the distance between the first guide roller 201 and the second guide roller 202 changes the angle θ between the first belt 203 and the second belt 204. Changing the angle between the first belt 203 and the second belt 204 alters the amount of graphite that present in the compression zone 207 between the first nip roller 205 and the second nip roller 206. The amount of graphite that is present in the compression zone 207 controls the density of the graphite after compression. In some embodiments the amount of graphite that is present in the compression zone 207 controls the basis weight of the graphite web. In some embodiments the amount of graphite that is present in the compression zone 207 controls the thickness of the graphite web. In some embodiments, the angle between the first belt 203 and the second belt 204 is about 30 degrees, about 35 degrees, about 40 degrees, about 45 degrees, about 50 degrees, about 55 degrees, about 60 degrees, about 65 degrees, about 70 degrees, about 75 degrees, about 80 degrees, about 85 degrees, about 90 degrees, about 95 degrees, about 100 degrees, about 105 degrees, about 110 degrees, about 115 degrees, about 120 degrees, about 125 degrees, about 130 degrees, about 135 degrees, about 140 degrees, about 145 degrees, about 150 degrees, or any range between any two of these values. In some embodiments, the angle between the first belt 203 and the second belt 204 is about 30 degrees to about 120 degrees, about 45 degrees to about 90 degrees, or about 60 degrees to about 75 degrees.

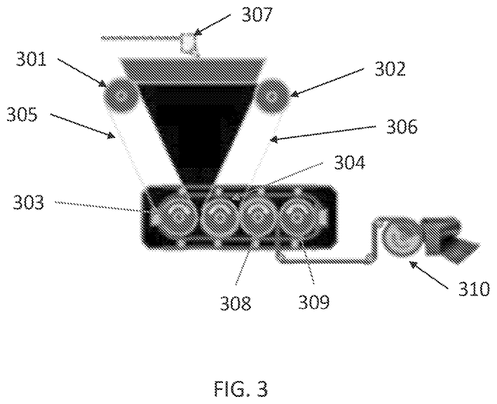

FIG. 3 illustrates a system with a hopper 307 configured to supply graphite, a first guide roller 301 and a second guide roller 302, a first nip roller 303 and a second nip roller 304, a first belt 305 attached to the first guide roller 301 and the first nip roller 303 and a second belt 306 attached to the second guide roller 302 and the second nip roller 304. In some embodiments, the first belt 305 and second belt 306 are configured to direct graphite from the first guide roller 301 and the second guide roller 302 to the first nip roller 303 and the second nip roller 304. In some embodiments, the first nip roller 303 and the second nip roller 304 are configured to compress the graphite as the graphite passes between the first nip roller 303 and the second nip roller 304. In some embodiments the system further comprises multiple embossing rollers 308/309 configured to emboss the graphite after the graphite after the graphite has been compressed. In some embodiments, the system further comprises at least one winding unit 310 configured to wind the graphite into a roll after the graphite is embossed.

In some embodiments, at least one of the first belt 305 and the second belt 306 has a surface which has a flow field pattern. The flow field pattern can correspond to a flow field pattern of a bipolar plate. In some embodiments, the flow field pattern is imprinted on the graphite as the graphite passes between the first nip roller 303 and the second nip roller 304. In some embodiments, at least one of the multiple embossing rollers 308/309 has a surface which has a flow field pattern, wherein the flow field pattern is identical to the flow field pattern on the surface of the first belt 305. In some embodiments, at least one of the multiple embossing rollers 308/309 has a surface which have a flow field pattern, wherein the flow field pattern is identical to the flow field pattern on the surface of the second belt 306. In some embodiments, the multiple embossing rollers 308/309 are configured to perform stepwise embossing on the graphite. The stepwise embossing comprises embossing the graphite to a certain level with the first of the multiple embossing rollers 308/309, further embossing the graphite to a deeper level with the next of the multiple embossing rollers 308/309 and continuing the process until reaching the final depth and shape of embossing with the final of the multiple embossing rollers 308/309. Certain considerations regarding basis weight distribution during the embossing process are explained in further detail below.

In some embodiments the system of FIG. 3 allows a pre-compression and/or pre-compacting by the belts 305/306 and/or the nip rollers 303/304. In some embodiments the belts 305/306 and/or the nip rollers 303/304 allow a pre-embossing of the graphite and/or graphite web. In some embodiments the rollers 308/309 allow a final embossing of the graphite and/or graphite web. In some embodiments the structured graphite web is rolled onto the winding unit 310. In some embodiments the structured graphite web represents graphite based bipolar plates.

In some embodiments the system of FIG. 3 represents an embossing belt multi rollers calender.

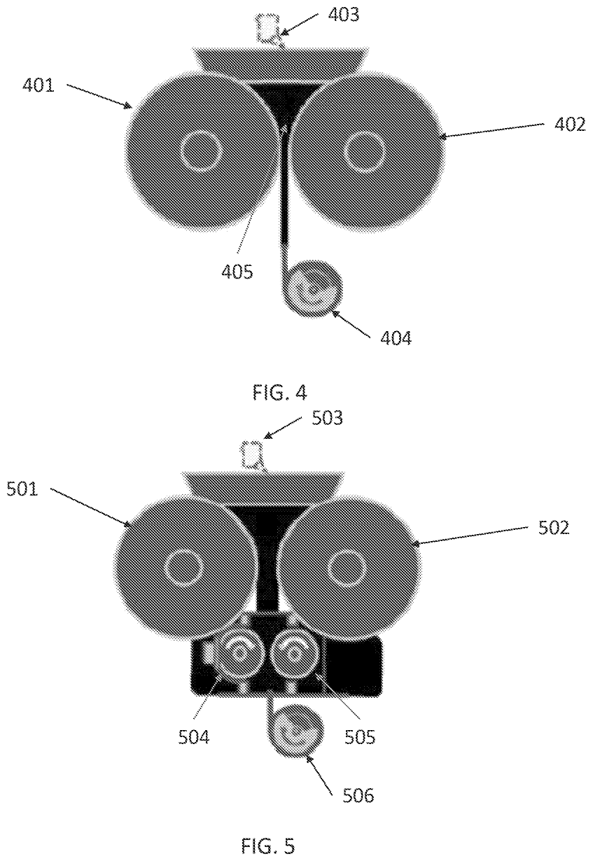

FIG. 4 illustrates a system comprising a first barrel roller 401, a second barrel roller 402, and a hopper 403 configured to supply graphite to the first barrel roller 401 and the second barrel roller 402. The first barrel roller 401 and the second barrel roller 402 are configured to compress and/or compact the graphite into a graphite web as the graphite passes between the first barrel roller 401 and the second barrel roller 402. In some embodiments, the system further comprises at least one winding unit 404 configured to wind the graphite web into a roll after compression. In some embodiments, the system further comprises one or more of a cutting unit, an impregnation unit, or a quality check unit.

In some embodiments, at least one of the first barrel roller 401 and the second barrel roller 402 has a surface which has a flow field pattern. In some embodiments, the flow field pattern corresponds to a flow field pattern of a bipolar plate. In some embodiments, the system is further configured to emboss the graphite as the graphite passes between the first barrel roller 401 and the second barrel roller 402. In some embodiments, the surface of at least one of the first barrel roller 401 and the second barrel roller 402 is porous. In some embodiments, the graphite comprises graphite flakes, and each of the pores in the first barrel roller 401 and the second barrel roller 402 is smaller than the size of the graphite flakes. In some embodiments, at least one of the first barrel roller 401 and the second barrel roller 402 is comprised of a screen. The porous barrel rollers 401/402 allow for air present in the graphite to be removed from the graphite during compression, as is preferred in the production of bipolar plates.

In some embodiments, the system further comprises at least one vacuum pump configured to create a vacuum around the first barrel roller 401 and the second barrel roller 402. The vacuum is configured to assist in the removal of air from the graphite during the production of the graphite web. In some embodiments, the vacuum pump is configured to create a vacuum of about 0.10 mbar, about 0.15 mbar, about 0.20 mbar, about 0.25 mbar, about 0.30 mbar, about 0.35 mbar, about 0.40 mbar, about 0.45 mbar, about 0.50 mbar, about 0.55 mbar, about 0.60 mbar, about 0.65 mbar, about 0.70 mbar, about 0.75 mbar, about 0.80 mbar, about 0.85 mbar, about 0.90 mbar, about 0.95 mbar, about 1.00 mbar, about 2 mbar, about 3 mbar, about 4 mbar, about 5 mbar, about 6 mbar, about 7 mbar, about 8 mbar, about 9 mbar, about 10 mbar, about 15 mbar, about 20 mbar, about 25 mbar, about 30 mbar, about 35 mbar, about 40 mbar, about 45 mbar, about 50 mbar, about 55 mbar, about 60 mbar, about 65 mbar, about 70 mbar, about 75 mbar, about 80 mbar, about 85 mbar, about 90 mbar, about 95 mbar, about 100 mbar, about 150 mbar, about 200 mbar, about 250 mbar, about 300 mbar, about 350 mbar, about 400 mbar, about 450 mbar, about 500 mbar, about 550 mbar, about 600 mbar, about 650 mbar, about 700 mbar, about 750 mbar, about 800 mbar, about 850 mbar, about 900 mbar, about 950 mbar, about 1000 mbar, or any range between any two of these values.

In some embodiments, the amount of graphite supplied by the hopper 403 is adjustable. In some embodiments, the amount of graphite provided by the hopper controls the amount of graphite present in the compression zone 405 between the first barrel roller 401 and the second barrel roller 402. The amount of graphite present in the compression zone 405 determines the density, the basis weight and/or the thickness of the graphite web after compression. In some embodiments, the distance between the first barrel roller 401 and the second barrel roller 402 can be adjusted to control the thickness of the graphite web. In some embodiments, the distance between the first barrel roller 401 and the second barrel roller 402 is about 0.30 mm, about 0.35 mm, about 0.40 mm, about 0.45 mm, about 0.50 mm, about 0.55 mm, about 0.60 mm, about 0.65 mm, about 0.70 mm, about 0.75 mm, about 0.80 mm, about 0.85 mm, about 0.90 mm, about 0.95 mm, about 1.0 mm, about 1.1 mm, about 1.2 mm, about 1.3 mm, about 1.4 mm, about 1.5 mm, about 1.6 mm, about 1.7 mm, about 1.8 mm, about 1.9 mm, about 2.0 mm, about 2.1 mm, about 2.2 mm, about 2.3 mm, about 2.4 mm, about 2.5 mm, about 2.6 mm, about 2.7 mm, about 2.8 mm, about 2.9 mm, about 3.0 mm, or any range between any two of these values. In some embodiments, the distance between the first barrel roller 401 and the second barrel roller 402 is about 0.3 mm to about 3.0 mm, about 0.6 mm to about 2.0 mm, or about 1.0 mm to about 1.5 mm.

In some embodiments, the first barrel roller 401 and the second barrel roller 402 have the same diameter. In some embodiments, the diameter of the first barrel roller 401 and the second barrel roller 402 is about 0.10 m, about 0.15 m, about 0.20 m, about 0.25 m, about 0.30 m, about 0.35 m, about 0.40 m, about 0.45 m, about 0.50 m, about 0.55 m, about 0.60 m, about 0.65 m, about 0.70 m, about 0.75 m, about 0.80 m, about 0.85 m, about 0.90 m, about 1.00 m, about 1.05 m, about 1.1 m, about 1.15 m, about 1.20 m, about 1.35 m, about 1.40 m, about 1.45 m, about 1.50 m, or any range between any two of these values.

In some embodiments the structured graphite web is rolled onto the winding unit 404. In some embodiments the structured graphite web represents graphite based bipolar plates. In some embodiments the system in FIG. 4 represents a system wherein the (pre-)compression and/or (pre-)compacting are taking place simultaneously with the embossing of the graphite and/or graphite web. In some embodiments the system of FIG. 4 represents a drum rollers calender.

FIG. 5 illustrates a system comprising a first barrel roller 501, a second barrel roller 502, and a hopper 503 configured to supply graphite to the first barrel roller 501 and the second barrel roller 502. The first barrel roller 501 and the second barrel roller 502 are configured to compress and/or compact the graphite into a graphite web as the graphite passes between the first barrel roller 501 and the second barrel roller 502. In some embodiments the system further comprises multiple embossing rollers 504/505 configured to emboss the graphite after the graphite after the graphite has been compressed and/or compacted. In some embodiments, the system further comprises at least one winding unit 506 configured to wind the graphite web into a roll after the graphite has been embossed.

In some embodiments a structured graphite web is rolled onto the winding unit 506. In some embodiments the structured graphite web represents graphite based bipolar plates. In some embodiments the system in FIG. 5 represents a system wherein the (pre-)compression and/or (pre-)compacting are taking place simultaneously with a pre-embossing and a following final embossing of the graphite and/or graphite web. In some embodiments the system of FIG. 5 represents a drum rollers calender.

In some embodiments, at least one of first barrel roller 501 or the second barrel roller 502 has a surface which has a flow field pattern. The flow field pattern can correspond to a flow field pattern of a bipolar plate. In some embodiments, the flow field pattern is imprinted on the graphite as the graphite passes between the first barrel roller 501 and the second barrel roller 502. In some embodiments, at least one of the multiple embossing rollers 504/505 has a surface which has a flow field pattern, wherein the flow field pattern is identical to the flow field pattern on the surface of the first barrel roller 501. In some embodiments, at least one of the multiple embossing rollers 504/505 has a surface which has a flow field pattern, wherein the flow field pattern is identical to the flow field pattern on the surface of the second barrel roller 502. In some embodiments, the system is configured to pre-emboss the graphite when the graphite passes between the first barrel roller 501 and the second barrel roller 502. In some embodiments, the system is configured to compress the graphite to a final thickness and density when the graphite passes between the multiple embossing rollers 504/505. In some embodiments, the system is configured to emboss the graphite to a final shape and density when the graphite passes between the multiple embossing rollers 504/505.

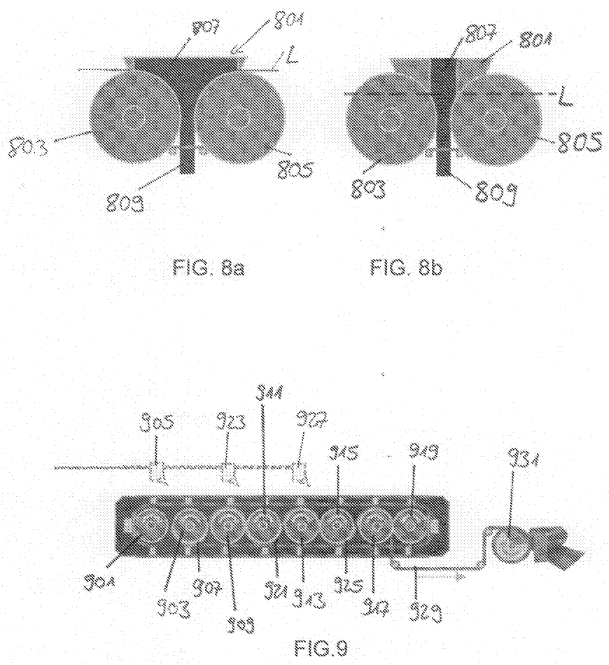

FIGS. 8a and 8b illustrate a system with different configurations of the feeder element and/or hopper 801. The system further comprises a first roller 803 and a second roller 805. The feeder element and/or hopper 801 is configured to supply graphite 807 to the first roller 803 and the second roller 805. In some embodiments the graphite 807 is provided as graphite flocks. The first roller 803 and the second roller 805 are configured to pre-compress and/or pre-compact, compress and/or compact, pre-emboss and/or emboss the graphite into a graphite web 809 and/or a structured graphite web 809. In some embodiments the first roller and/or the second roller are configured as nip roller, as barrel rollers, as embossing rollers and/or as feeding rollers. As can be taken from a comparison of FIGS. 8a and 8b the feeder element has been adjusted to change a level L at which the graphite gets into first contact with the rollers 803/805. In the configuration shown in FIG. 8a the level L is higher than in the configuration shown in FIG. 8b.

By changing the level L at which the graphite gets into first contact with the rollers 803/805 the basis weight of the graphite web 809 can be adjusted and/or changed. In some embodiments the basis weight of the graphite web 809 produced in the configuration of FIG. 8a is increased compared to the basis weight of the graphite web 809 produced in the configuration of FIG. 8b.

In some embodiments the level L is adapted by the fill height of the graphite 807 within the feeder element and/or hopper 801.

In some embodiments a thickness of the graphite web 809 can additionally be adjusted by changing the distance between the rollers 803/805.

It is important to note that also by the adjustment of the height of level L the thickness of the web 809 existing the rollers 803/805 can be indirectly changed by the change of the basis weight and the different elastic properties of the web for different basis weights.

In case the thickness of the graphite web 809 is not identical to a target thickness further the graphite web 809 can be further processed in further calendaring systems. In some embodiments these calendaring systems

FIG. 9 illustrates a system with a first roller 901 and a second roller 903. Graphite is provided to the rollers 901/903 by a first feeder element and/or hopper 905. The rollers 901/903 can be configured to pre-compress and/or pre-compact, compress and/or compact, pre-emboss and/or emboss the graphite into a graphite web 907. The system of FIG. 9 further comprises three further pairs of first and second rollers 909/911, 913/915, and 917/919. The roller 909 represents a second first roller and the roller 911 represents a second second roller. The roller 913 represents a third first roller and the roller 915 represents a third second roller. The roller 917 represents a fourth first roller and the roller 917 represents a fourth second roller.

In some embodiments the second pair of rollers 909/911 further processes the graphite web 907 into the graphite web 921. In some embodiments the further processing of the graphite web 907 by the rollers 909/911 comprises a further calendaring, a further compression and/or compacting and/or a pre-embossing of the graphite web 907.

In some embodiments the system further comprises a further second feeder element and/or hopper 923. In some embodiments the second feeder element and/or hopper 923 allows to supply further graphite and/or graphite flocks to the rollers 909/911 and/or the graphite web 907. In some embodiments the supply of graphite by the second feeder element and/or hopper 923 is controlled based on a measurement of the basis weight and/or thickness of the graphite web 907. By the further supply of graphite by the second feeder element and/or hopper 923 the basis weight and/or thickness of the graphite web 921 can be changed and/or adjusted.

In some embodiments the graphite web 921 is further processed into a graphite web 925 by the rollers 913/915. In some embodiments the further processing of the graphite web 921 by the rollers 913/915 comprises a further calendaring, a further compression and/or compacting and/or a pre-embossing of the graphite web 921.

In some embodiments further graphite and/or graphite flocks can be suppled to the rollers 913/915 and/or the graphite web 921 by a further third feeder element and/or hopper 927. In some embodiments the supply of graphite by the third feeder element and/or hopper 927 is controlled based on a measurement of the basis weight and/or thickness of the graphite web 921 and/or the graphite web 907. By the further supply of graphite by the third feeder element and/or hopper 927 the basis weight and/or thickness of the graphite web 925 can be changed and/or adjusted.

In some embodiments the fourth pair of rollers 917/919 can be used to further process the graphite web 925 into the graphite web 929. In some embodiments the further processing In some embodiments the further processing of the graphite web 925 by the rollers 917/919 comprises a further calendaring, a further compression and/or compacting and/or an embossing of the graphite web 925.

In some embodiments the system further comprises at least one winding unit 931 configured to wind the graphite web 929. In some embodiments the graphite web 929 represents a structured graphite web and/or graphite based bipolar plates.

In some embodiments the distance between the pair rollers 901/903, the distance between the pair of rollers 909/911, the distance between the pair of rollers 913/915 and/or the distance between the pair of rollers 917/919 is different. In some embodiments the distance can decrease for roller pair to roller pair to gradually reduce a thickness of the respective graphite webs 907, 921, 925 and 929, respectively. By this gradual decrease, the rate of existing air can be increased and/or the precision of reaching a target basis weight and/or thickness of the graphite web 929 can be increased. Alternatively, or additionally the homogeneity of the basis weight and/or the thickness of the graphite web 929 can be increased.

In some embodiments the transport of the graphite webs 907, 921, 925 and/or 929 can be accomplished by different rotational speeds and/or surface velocities of the pair of rollers. In some embodiments the rotational speed and/or surface velocity of the rollers and/or the pair of rollers increases from the first roller 901 to the fourth second roller 919. In some embodiments the two rollers within the pair of rollers 901/903, 909/911, 913/915, and/or 917/919 have the same rotational speed and/or surface velocity. Alternatively or additionally the rollers of two of these pairs have the same rotational speed and/or surface velocities.

In some embodiments the transport of the graphite webs 907, 921, 925 and/or 929 can be accomplished by different surface structures of the pair of rollers. In some embodiments the friction coefficient and/or roughness coefficient of the surface of the rollers and/or the pair of rollers contacting the graphite web 907, 921, 925 and/or 929 increases from the first roller 901 to the fourth second roller 919. In some embodiments the surface of two rollers within the pair of rollers 901/903, 909/911, 913/915, and/or 917/919 have the same friction coefficient and/or roughness coefficient. Alternatively of additionally the rollers of two of these pairs have surfaces having the same friction coefficient and/or roughness coefficient.

In some embodiments, a multi roller system, such as that illustrated in FIG. 9, is configured to accommodate customer designed embossing requirements by allowing control over basis weight (mg/sc) and density of the graphite web during compression. As explained above, in some embodiments, a flow field pattern is embossed on the graphite web after the graphite web is compressed between the rollers. Appropriate basis weight is crucial to the embossing step because different embossing depths require different basis weights to ensure consistent porosity and density within the graphite web after the embossing process. Therefore, in order to accommodate customer designs, the multi roller system herein can generate varying basis weights across the graphite web.

In some embodiments, the basis weight is adjusted by adjusting the number of rolls, and consequently the number of roll gaps, in conjunction with the number of feeder element and/or hopper. With reference to the embodiment illustrated in FIG. 9, graphite and/or graphite flocks is provided to the gap between the first first roller and first second roller pair 901/903 by a first feeder element and/or hopper 905. The embodiment further comprises a second feeder element and/or hopper 923, which allows for supply of additional graphite to the gap between the second first roller and second second roller pair 909/911. The additional supply of graphite by the second feeder element and/or hopper 923 increases the basis weight and density of graphite web 921.

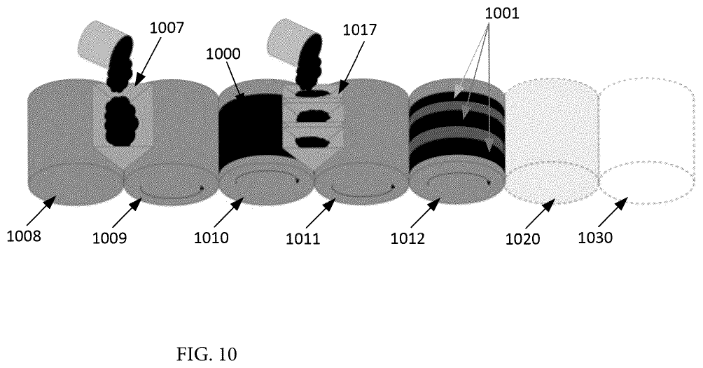

FIG. 10 illustrates a multi roller system with rollers 1008, 1009, 1010, 1011, and 1012. The rollers are configured to compress graphite flakes into continuous graphite web 1000. The system of FIG. 10 further comprises a first feeder element and/or hopper 1007 and a second feeder element and/or hopper 1017 to enable controlled graphite deposition, which in turn affects the basis weight and density of graphite web 1000 after compression.

Graphite is initially fed to the roller gap between rollers 1008 and 1009 via first feeder element and/or hopper 1007. Rollers 1008 and 1009 compress the graphite into graphite web 1000. Second feeder element and/or hopper 1017 allows for additional supply of graphite to the roller gap between rollers 1010 and 1011. As shown in FIG. 10, second feeder element and/or hopper 1017 comprises three compartments, which are spaced apart to allow for precise deposition of graphite across the width of graphite web 1000.

In this embodiment, the compartmentalized design of second feeder element and/or hopper 1017 enables targeted deposition of graphite, ensuring that specific sections of graphite web 1000 receive specific amounts of additional graphite. This in turn allows for precise adjustment of basis weight and density across the width of graphite web 1000. Graphite is selectively deposited on specific regions of graphite web 1000, ensuring proper basis weight and density distribution across those specific regions to accommodate customer designs. This results in a graphite web with density variations across its width as desired. This is illustrated in FIG. 10 as stripes 1001, which are areas of increased basis weight and density that correspond to the additional graphite deposited via the three compartments of second feeder element and/or hopper 1017.

The embodiment illustrated in FIG. 10 further comprises embossing rollers 1020 and 1030 that are configured to emboss graphite web 1000 after it is compressed. Following compression with controlled adjustment of basis weight and density, graphite web 1000 passes through embossing rollers 1020 and 1030. As explained above, embossing is used to imprint surface patterns, such as a flow field pattern, on the graphite web. Appropriate basis weight and density distribution is crucial to the embossing step because different embossing depths require different basis weights to ensure consistent porosity and density within the graphite web.

In some embodiments, the porosity ranges from 15% to 20% across the entire graphite web. In some embodiments, the difference in basis weight across the graphite web ranges from 5% to 200%. In other embodiments, the difference in basis weight across a bipolar plate area ranges from 50% to 100%.

The embodiment illustrated in FIG. 10 allows for variance of basis weight and density across a width of the graphite web by controlling graphite deposition at specific roller gaps. In other embodiments, basis weight may be varied by both adding more graphite via the feeder element and/or hopper at specific roller gaps, as well as by omitting graphite at specific roller gaps. In some embodiments, the multi roller system may be configured with additional feeder element and/or hopper at other roller gaps to further control graphite deposition.

In some embodiments, the feeder element and/or hopper comprises a different number of compartments depending on the desired basis weight and density distribution per customer design. In other embodiments, the number of roller gaps are higher or lower, enabling increased or decreased opportunities for adding additional graphite. In some embodiments, the number of roller gaps ranges from 1 to 20. The more roller gaps there are, the larger the basis weight differences will be across the graphite web because the multi roller system provides more flexibility on where and how much additional graphite to add or omit. In some embodiments, basis weight increases by 10 mg/sc per roller gap.

In some embodiments, the basis weight is adjusted by adjusting the roller diameter. With reference to the embodiment illustrated in FIG. 9, the diameter of each of the four pairs of first and second rollers 901/903, 909/911, 913/915, and 917/919 ranges from 0.1 m to 1 m. Larger roller diameters result in higher increase in basis weights. In other embodiments, the diameter ranges from 0.2 m to 0.5 m. In some embodiments, the diameter of each of the four pairs of first and second rollers is different depending on the desired basis weight distribution. By varying the roller diameter, the basis weight and density of the graphite web are accordingly adjusted, ensuring a distribution of appropriate final density across the graphite web for embossing.

In some embodiments, the basis weight is adjusted by adjusting the surface roughness of the rollers. With reference to the embodiment illustrated in FIG. 9, the surface roughness of each of the four pairs of first and second rollers 901/903, 909/911, 913/915, and 917/919 ranges from 50 to 1000 grits. In some embodiments, the surface roughness of the rollers is equivalent to that of sandpaper. Rollers with rougher surfaces result in higher increase in basis weights. In other embodiments, the surface roughness ranges from 100 to 200 grits. By varying the surface roughness of the rollers, the basis weight and density of the graphite web are accordingly adjusted, ensuring a distribution of appropriate final density across the graphite web for embossing.

In some embodiments, the multi roller system is configured to have at least two rollers with different friction or roughness. In some embodiments, the friction ratio ranges from 1% to 20%.

In some embodiments, a drying mechanism is integrated into the multi roller system to remove residual moisture from the graphite web before embossing. Due to storage or operating conditions, moisture may accumulate within the graphite, which is removed during the compression process. In some embodiments, at least one roller comprises a heating unit such that the roller becomes heated. The heated roller is configured to dry the graphite web by applying heat during the compression process. In some embodiments, the temperature of the heated rollers ranges from 50° C. to 200° C. In other embodiments, at least one heating unit is placed above the multi roller system, and is configured to apply heat to the graphite web during the compression process. In some embodiments, the temperature of the heating unit ranges from 50° C. to 200° C.

In addition to having embossing rollers, some embodiments are also configured with cutting rollers that are configured to directly structure the graphite web. Other embodiments are configured with combination rollers that are configured to both cut and emboss the graphite web.

In some embodiments, the rollers are configured to rotate at different speeds to transfer the graphite web from one roller to the next. With reference to the embodiment illustrated in FIG. 9, each of the four pairs of first and second rollers 901/903, 909/911, 913/915, and 917/919 rotate at different speeds as they transfer graphite web 921 from roller 901 to roller 919. In some embodiments, the roll speed decreases from first first roller 901 to fourth second roller 919. In other embodiments that comprise embossing rollers, the roller speed decreases from the first roller to the embossing rollers, but the embossing rollers run in synchronization.

In some embodiments, the gap between two consecutive rollers is progressively decreased from the first gap to the last gap. With reference to the embodiment illustrated in FIG. 10, the gap between rollers 901 and 903 is the largest, followed by the gap between rollers 909 and 911 and so on, with the gap between rollers 917 and 919 being the smallest. The initial gap width is determined based on the total number of roller gaps required to achieve the desired basis weight as the graphite web is further compressed as it passes through each progressive roller gap. In some embodiments, the number of rollers and the distance between each roller is configured to accommodate a predetermined basis weight or density when passing the graphite web through the gaps. The system is configured such that the final desired density for embossing is achieved at the final roller gap. In some embodiments, the roller gap reduction ranges from 50 μm to 500 μm. In other embodiments, the roller gap reduction ranges from 50 μm to 200 μm. In some embodiments, reduction of the roller gap width can lead to improved transfer to the graphite web across the rollers. In some embodiments, the gap between each consecutive rollers is the same.

### Methods of Use

Methods can be performed to compress graphite to form a continuous, uniform graphite web using the above-described systems.

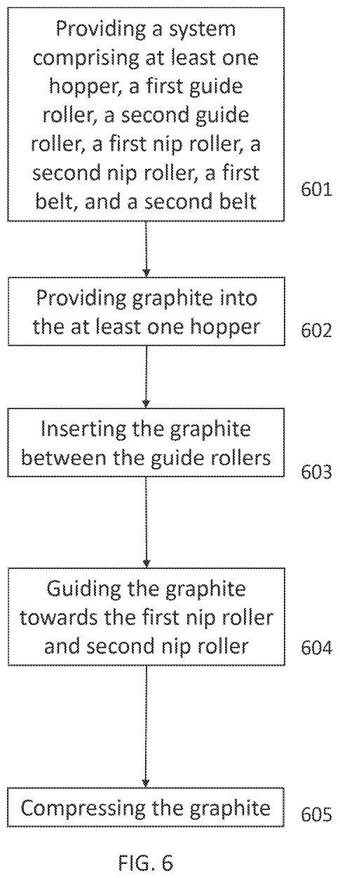

FIG. 6 illustrates a diagram for compressing graphite into a continuous graphite web. The method comprises providing 601 a system, wherein the system comprises, at least one hopper, a first guide roller, a second guide roller, a first nip roller, a second nip roller, a first belt attached to the first guide roller and the first nip roller, a second belt attached to the second guide roller and the second nip roller, providing 602 graphite to the at least one hopper, inserting 603 the graphite between the first guide roller and the second guide roller using the at least one hopper, guiding 604 the graphite towards the first nip roller and second nip roller using the first belt and the second belt, and compressing 605 the graphite using the first nip roller and the second nip roller to form a graphite web. In some embodiments, the method further comprises providing at least one winding unit and winding the graphite web into a roll.

In some embodiments, at least one of the first belt and the second belt has a surface which has a flow field pattern. The flow field pattern can correspond to a flow field pattern of a bipolar plate. In some embodiments, the flow field pattern is embossed on the graphite as the graphite is compressed 605 between the first nip roller and the second nip roller. In some embodiments, at least one or both of the first belt and the second belt is porous. In some embodiments, the graphite comprises graphite flakes, and each of the pores in the first belt and the second belt is smaller than the size of the graphite flakes. In some embodiments, at least one or both of the first belt and the second belt is comprised of a screen. The porous belts allow for air present in the graphite to be removed from the graphite during compression 605, as is preferred in the production of bipolar plates.

The graphite can be compressed 605 into a graphite web of any thickness. In some embodiments, the graphite is compressed 605 to a thickness of about 0.30 mm, about 0.35 mm, about 0.40 mm, about 0.45 mm, about 0.50 mm, about 0.55 mm, about 0.60 mm, about 0.65 mm, about 0.70 mm, about 0.75 mm, about 0.80 mm, about 0.85 mm, about 0.90 mm, about 0.95 mm, about 1.0 mm, about 1.1 mm, about 1.2 mm, about 1.3 mm, about 1.4 mm, about 1.5 mm, about 1.6 mm, about 1.7 mm, about 1.8 mm, about 1.9 mm, about 2.0 mm, about 2.1 mm, about 2.2 mm, about 2.3 mm, about 2.4 mm, about 2.5 mm, about 2.6 mm, about 2.7 mm, about 2.8 mm, about 2.9 mm, about 3.0 mm or any range between any two of these values. In some embodiments, the graphite is compressed 605 to a thickness of about 0.3 mm to about 3.0 mm, about 0.6 mm to about 2.0 mm, or about 1.0 mm to about 1.5 mm.

In some embodiments, the method further comprises providing multiple embossing rollers and embossing the graphite after the graphite has been compressed 605. In some embodiments, at least one of the multiple embossing rollers has a surface which has a flow field pattern, wherein the flow field pattern is identical to the flow field pattern on the surface of the first belt. In some embodiments, at least one of the multiple embossing rollers has a surface which has a flow field pattern, wherein the flow field pattern is identical to the flow field pattern on the surface of the second belt. In some embodiments, the embossing comprises performing stepwise embossing using the multiple embossing rollers. The stepwise embossing comprises embossing the graphite to a certain level with the first of the multiple embossing rollers, further embossing the graphite to a deeper level with the next of the multiple embossing rollers and continuing the process until reaching the final depth and shape of embossing with the final of the multiple embossing rollers.

In some embodiments, the method further comprises providing at least one vacuum pump and creating a vacuum around the first belt and the second belt prior to compressing 605 the graphite. In some embodiments, the vacuum creates a pressure of about 0.10 mbar, about 0.15 mbar, about 0.20 mbar, about 0.25 mbar, about 0.30 mbar, about 0.35 mbar, about 0.40 mbar, about 0.45 mbar, about 0.50 mbar, about 0.55 mbar, about 0.60 mbar, about 0.65 mbar, about 0.70 mbar, about 0.75 mbar, about 0.80 mbar, about 0.85 mbar, about 0.90 mbar, about 0.95 mbar, about 1.00 mbar, about 2 mbar, about 3 mbar, about 4 mbar, about 5 mbar, about 6 mbar, about 7 mbar, about 8 mbar, about 9 mbar, about 10 mbar, about 15 mbar, about 20 mbar, about 25 mbar, about 30 mbar, about 35 mbar, about 40 mbar, about 45 mbar, about 50 mbar, about 55 mbar, about 60 mbar, about 65 mbar, about 70 mbar, about 75 mbar, about 80 mbar, about 85 mbar, about 90 mbar, about 95 mbar, about 100 mbar, about 150 mbar, about 200 mbar, about 250 mbar, about 300 mbar, about 350 mbar, about 400 mbar, about 450 mbar, about 500 mbar, about 550 mbar, about 600 mbar, about 650 mbar, about 700 mbar, about 750 mbar, about 800 mbar, about 850 mbar, about 900 mbar, about 950 mbar, about 1000 mbar, or any range between any two of these values.

In some embodiments, the method further comprises providing an impregnation unit and impregnating the graphite web with a resin or thermoplastic. In some embodiments, the method further comprises providing a cutting unit and cutting the graphite web into multiple processed graphite plates. In some embodiments, the method further comprises providing a quality control unit and examining the graphite. In some embodiments, examining the graphite web includes determining the number of defects present. In some embodiments, examining the graphite web includes determining the thermal conductivity of the graphite web. In some embodiments, examining the graphite web includes determining the electrical conductivity of the graphite web.

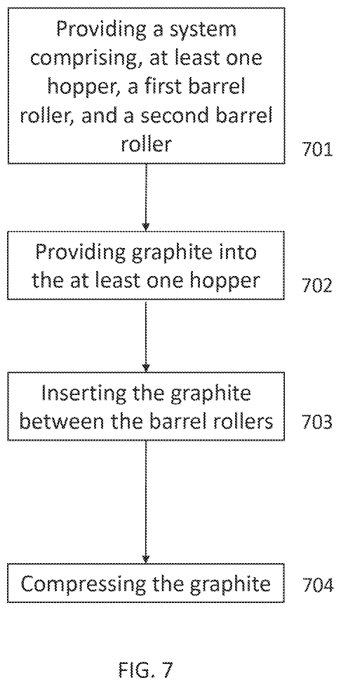

FIG. 7 illustrates a diagram for compressing graphite into a continuous graphite web. The method comprises providing 701 a system, wherein the system comprises at least one hopper, a first barrel roller, and a second barrel roller, providing 702 graphite into the at least one hopper, inserting 703 the graphite between the first barrel roller and the second barrel roller using the at least one hopper, and compressing 704 the graphite using the first barrel roller and the second barrel roller.

In some embodiments, at least one of the first barrel roller and the second barrel roller has a surface which has a flow field pattern. The flow field pattern can correspond to a flow field pattern of a bipolar plate. In some embodiments, the flow field pattern is embossed on the graphite as the graphite is compressed 704 between the first barrel roller and the second barrel roller. In some embodiments, at least one of the first barrel roller and the second barrel roller is porous. In some embodiments, the graphite comprises graphite flakes, and each of the pores in the first barrel roller and the second barrel roller is smaller than the size of the graphite flakes. In some embodiments, at least one of the first barrel roller and the second barrel roller is comprised of a screen. The porous barrel rollers allow for air present in the graphite to be removed from the graphite during compression 704, as is preferred in the production of bipolar plates.

The graphite can be compressed 704 into a graphite web of any thickness. In some embodiments, the graphite is compressed 704 to a thickness of about 0.30 mm, about 0.35 mm, about 0.40 mm, about 0.45 mm, about 0.50 mm, about 0.55 mm, about 0.60 mm, about 0.65 mm, about 0.70 mm, about 0.75 mm, about 0.80 mm, about 0.85 mm, about 0.90 mm, about 0.95 mm, about 1.0 mm, about 1.1 mm, about 1.2 mm, about 1.3 mm, about 1.4 mm, about 1.5 mm, about 1.6 mm, about 1.7 mm, about 1.8 mm, about 1.9 mm, about 2.0 mm, about 2.1 mm, about 2.2 mm, about 2.3 mm, about 2.4 mm, about 2.5 mm, about 2.6 mm, about 2.7 mm, about 2.8 mm, about 2.9 mm, about 3.0 mm or any range between any two of these values. In some embodiments, the graphite is compressed 704 to a thickness of about 0.3 mm to about 3.0 mm, about 0.6 mm to about 2.0 mm, or about 1.0 mm to about 1.5 mm.

In some embodiments, the method further comprises providing multiple embossing rollers and embossing the graphite after the graphite has been compressed 704. In some embodiments, at least one of the multiple embossing rollers has a surface which has a flow field pattern, wherein the flow field pattern is identical to the flow field pattern on the surface of the first barrel roller. In some embodiments, at least one of the multiple embossing rollers has a surface which has a flow field pattern, wherein the flow field pattern is identical to the flow field pattern on the surface of the second barrel roller. In some embodiments, the compressing 704 of the graphite comprises pre-embossing the graphite to a first depth. In some embodiments, the embossing comprises embossing the pre-embossed graphite to a final depth.

In some embodiments, the method further comprises providing at least one vacuum pump and creating a vacuum around the first barrel roller and the second barrel roller prior to compressing 704 the graphite. In some embodiments, the vacuum creates a pressure of about 0.10 mbar, about 0.15 mbar, about 0.20 mbar, about 0.25 mbar, about 0.30 mbar, about 0.35 mbar, about 0.40 mbar, about 0.45 mbar, about 0.50 mbar, about 0.55 mbar, about 0.60 mbar, about 0.65 mbar, about 0.70 mbar, about 0.75 mbar, about 0.80 mbar, about 0.85 mbar, about 0.90 mbar, about 0.95 mbar, about 1.00 mbar, about 2 mbar, about 3 mbar, about 4 mbar, about 5 mbar, about 6 mbar, about 7 mbar, about 8 mbar, about 9 mbar, about 10 mbar, about 15 mbar, about 20 mbar, about 25 mbar, about 30 mbar, about 35 mbar, about 40 mbar, about 45 mbar, about 50 mbar, about 55 mbar, about 60 mbar, about 65 mbar, about 70 mbar, about 75 mbar, about 80 mbar, about 85 mbar, about 90 mbar, about 95 mbar, about 100 mbar, about 150 mbar, about 200 mbar, about 250 mbar, about 300 mbar, about 350 mbar, about 400 mbar, about 450 mbar, about 500 mbar, about 550 mbar, about 600 mbar, about 650 mbar, about 700 mbar, about 750 mbar, about 800 mbar, about 850 mbar, about 900 mbar, about 950 mbar, about 1000, or any range between any two of these values.

In some embodiments, the method further comprises providing an impregnation unit and impregnating the graphite web with at least one resin or thermoplastic. In some embodiments, the method further comprises providing at least one cutting unit and cutting the graphite web into multiple processed graphite plates after embossing. In some embodiments, the method further comprises providing at least one quality control unit and examining the graphite web after embossing. In some embodiments, examining the graphite web includes determining the presence and or number of defects present. In some embodiments, examining the graphite web includes determining the thermal conductivity of the graphite web. In some embodiments, examining the graphite web includes determining the electrical conductivity of the graphite web.

In some embodiments the method lead to a pre-product. In some embodiments the pre-product is wound onto a roll and stored and/or transported. In some embodiments the pre-product is further processed, in particular calendered and/or embossed, in a further step and/or further system. In some embodiments the further processing is timely and or locally separated from the production if the pre-product.

In some embodiments the basis weight of the graphite web is defined and/or adjusted by the diameter of the roller and/or the amount of graphite fed to the respective roller. In some embodiments the basis weight of the graphite web is defined and/or adjusted by the number of roller pairs, diameter of the rollers and/or distance of the rollers through which the graphite is led.

In some embodiments, the method further comprises adjusting the basis weight and density of the compressed graphite web in order to accommodate customer designed embossing requirements. In some embodiments, the basis weight is adjusted through targeted deposition of graphite on the graphite web.

In some embodiments the used systems and methods allow to improve the formation of structures by pretreating the graphite and/or graphite web, without the disadvantages of the technics used in the prior art. These prior art methods lead to an uneven compacting of the graphite and/or graphite web. For example the surface is more compacted that the core making often in the prior art a further processing step, in particular a scoring step, necessary. The material and/or graphite processed by the claimed system and methods is pre-distributed so that an even compression/compacting is reached to allow the structures to form more cleanly in an embossing step.

As explained before in the described systems and methods an air bubble formation is eliminated, at least reduced and/or the graphite web is pre-calendered (near a target thickness) to reduce the air in the graphite material. The subsequent embossing process is optionally repeated multiple times. With each repetition, more air escapes, and the bubbles disappear.

In some embodiments of the manufacturing process of the graphite base material and/or graphite web, the expanded graphite flakes and/or worms are more favorably oriented for the embossing process.

### Graphite Webs Prepared by the Above-Described Process

Graphite webs can be produced using the above-described methods. In some embodiments, a processed graphite web is produced by providing graphite, providing at least one hopper, providing a first guide roller, providing a second guide roller, providing a first nip roller, providing a second nip roller, providing a first belt attached to the first guide roller and the first nip roller, providing a second belt attached to the second guide roller and the second nip roller, inserting the graphite between the first guide roller and the second guide roller using the at least one hopper, guiding the graphite towards the first nip roller and second nip roller using the first belt and the second belt, and compressing the graphite using the first nip roller and the second nip roller. In some embodiments, the production of the processed graphite web further comprises providing an embossing tool and embossing the graphite web. In some embodiments, the production of the processed graphite web further comprises providing at least one vacuum pump and creating a vacuum around the first belt and the second belt. In some embodiments, the production of the processed graphite web further comprises providing at least one impregnation unit and impregnating the graphite web with at least one resin or thermoplastic. In some embodiments, the production of the processed graphite web further comprises providing at least one cutting unit and cutting the processed graphite web into multiple processed graphite plates.

The processed graphite web can generally have any thickness. In some embodiments, the processed graphite web has a thickness of about 0.30 mm, about 0.35 mm, about 0.40 mm, about 0.45 mm, about 0.50 mm, about 0.55 mm, about 0.60 mm, about 0.65 mm, about 0.70 mm, about 0.75 mm, about 0.80 mm, about 0.85 mm, about 0.90 mm, about 0.95 mm, about 1.0 mm, about 1.1 mm, about 1.2 mm, about 1.3 mm, about 1.4 mm, about 1.5 mm, about 1.6 mm, about 1.7 mm, about 1.8 mm, about 1.9 mm, about 2.0 mm, about 2.1 mm, about 2.2 mm, about 2.3 mm, about 2.4 mm, about 2.5 mm, about 2.6 mm, about 2.7 mm, about 2.8 mm, about 2.9 mm, about 3.0 mm, about 3.5 mm, about 4.0 mm, about 4.5 mm, about 5.0 mm or any range between any two of these values. In some embodiments, the processed graphite web has a thickness of about 0.3 mm to about 3.0 mm, about 0.6 mm to about 2.0 mm, or about 1.0 mm to about 1.5 mm.

The processed graphite web can have any density. In some embodiments, the processed graphite web has a uniform density. In some embodiments, the processed graphite web has a density of about 0.05 g/cc, about 0.10 g/cc, about 0.15 g/cc, 0.20 g/cc, about 0.25 g/cc, about 0.30 g/cc, about 0.35 g/cc, about 0.40 g/cc, about 0.45 g/cc, 0.50 g/cc, about 0.55 g/cc, about 0.60 g/cc, about 0.65 g/cc, about 0.70 g/cc, about 0.75 g/cc, about 0.80 g/cc, about 0.85 g/cc, about 0.90 g/cc, about 0.95, about 1.00 g/cc, about 1.05 g/cc, about 1.10 g/cc, about 1.15 g/cc, about 1.20 g/cc, about 1.25 g/cc, about 1.30 g/cc, about 1.35 g/cc, about 1.40 g/cc, about 1.45 g/cc, about 1.50 g/cc, about 1.55 g/cc, about 1.60 g/cc, about 1.65 g/cc, about 1.70 g/cc, about 1.75 g/cc, about 1.80 g/cc, about 1.85 g/cc, about 1.90 g/cc, about 1.95 g/cc, about 2.00 g/cc, or any range between any two of these values. In some embodiments, the processed graphite web has a density of about 1.00 g/cc to about 2.00 g/cc, about 1.20 g/cc to about 1.80 g/cc, or about 1.60 g/cc to about 1.75 g/cc. In some embodiments, the processed graphite web has a surface which has a flow field geometry.

In some embodiments, a processed graphite web has varying basis weight and density across its width.

In some embodiments, a processed graphite web is produced by providing graphite, providing at least one hopper, providing a first barrel roller, providing a second barrel roller, inserting the graphite between the first barrel roller and the second barrel roller using the at least one hopper, and compressing the graphite using the first barrel roller and the second barrel roller. In some embodiments, the production of the processed graphite web further comprises providing an embossing tool and embossing the graphite web. In some embodiments, the production of the processed graphite web further comprises providing an embossing tool and embossing the graphite web. In some embodiments, the production of the processed graphite web further comprises providing at least one vacuum pump and creating a vacuum around the first belt and the second belt. In some embodiments, the production of the processed graphite web further comprises providing at least one impregnation unit and impregnating the graphite web with at least one resin or thermoplastic. In some embodiments, the production of the processed graphite web further comprises providing a cutting unit and cutting the processed graphite web into multiple processed graphite plates.

The processed graphite plate can generally have any thickness. In some embodiments, the processed graphite plate has a thickness of about 0.30 mm, about 0.35 mm, about 0.40 mm, about 0.45 mm, about 0.50 mm, about 0.55 mm, about 0.60 mm, about 0.65 mm, about 0.70 mm, about 0.75 mm, about 0.80 mm, about 0.85 mm, about 0.90 mm, about 0.95 mm, about 1.0 mm, about 1.1 mm, about 1.2 mm, about 1.3 mm, about 1.4 mm, about 1.5 mm, about 1.6 mm, about 1.7 mm, about 1.8 mm, about 1.9 mm, about 2.0 mm, about 2.1 mm, about 2.2 mm, about 2.3 mm, about 2.4 mm, about 2.5 mm, about 2.6 mm, about 2.7 mm, about 2.8 mm, about 2.9 mm, about 3.0 mm or any range between any two of these values. In some embodiments, the processed graphite plate has a thickness of about 0.3 mm to about 3.0 mm, about 0.4 mm to about 1.0 mm, or about 0.45 mm to about 0.55 mm.

The processed graphite web can have any density. In some embodiments, the processed graphite web has a uniform density. In some embodiments, the processed graphite web has a density of about 1.00 g/cc, about 1.05 g/cc, about 1.10 g/cc, about 1.15 g/cc, about 1.20 g/cc, about 1.25 g/cc, about 1.30 g/cc, about 1.35 g/cc, about 1.40 g/cc, about 1.45 g/cc, about 1.50 g/cc, about 1.55 g/cc, about 1.60 g/cc, about 1.65 g/cc, about 1.70 g/cc, about 1.75 g/cc, about 1.80 g/cc, about 1.85 g/cc, about 1.90 g/cc, about 1.95 g/cc, about 2.00 g/cc, or any range between any two of these values. In some embodiments, the processed graphite web has a density of about 1.00 g/cc to about 2.00 g/cc, about 1.20 g/cc to about 1.80 g/cc, or about 1.60 g/cc to about 1.75 g/cc. In some embodiments, the processed graphite web has a surface which has a flow field geometry.

### Examples

Various of the above-disclosed and other features and functions, or alternatives thereof, may be combined into many other different systems or applications. Various presently unforeseen or unanticipated alternatives, modifications, variations, or improvements therein may be subsequently made by those skilled in the art, each of which is also intended to be encompassed by the disclosed embodiments.

1. A system for adjustably compressing graphite, the system comprising:
at least one feeder element or hopper configured to supply graphite; and
a first roller and a second roller configured to compress graphite as the graphite passes between the first roller and the second roller.

2. The system of claim 1, wherein the at least one feeder element or hopper is compartmentalized.

3. The system of claim 2, wherein the compartmentalized feeder element or hopper is configured to allow targeted deposition of graphite across a width of the compressed graphite.

4. The system of claim 2, wherein the compartmentalized feeder element or hopper is configured to selectively omit the supply of graphite to specific regions of the compressed graphite.

5. The system of claim 3, wherein the compressed graphite has variations in basis weight and density corresponding to the targeted deposition of graphite.

6. The system of claim 5, wherein the variations in basis weight and density correspond to desired embossing depths.

7. The system of claim 1, wherein a basis weight of the compressed graphite is adjusted by adjusting a diameter of at least one roller.

8. The system of claim 1, wherein a basis weight of the compressed graphite is adjusted by adding more rollers.

9. The system of claim 1, wherein the first roller and the second roller each have a surface, wherein the surfaces each have a surface roughness.

10. The system of claim 9, wherein a basis weight of the compressed graphite is adjusted by adjusting the surface roughness of at least one roller.

11. The system of claim 10, wherein the basis weight increases with increasing surface roughness.

12. The system of claim 1, further comprising a plurality of first rollers and second rollers arranged in a sequence.

13. The system of claim 12, wherein gaps between consecutive rollers is constant.

14. The system of claim 12, wherein the system comprises adjustable gaps between consecutive rollers, wherein a first gap is defined between a first pair of rollers in the sequence and a last gap is defined between a final pair of rollers in the sequence.

15. The system of claim 14, wherein a width of each of the gaps between consecutive rollers is progressively decreased from the first gap to the last gap.

16. The system of claim 15, wherein the width is determined based on a final desired basis weight of the compressed graphite.

17. The system of claim 14, wherein a basis weight of the compressed graphite is adjusted by adjusting the number of rollers and an amount of graphite supplied at each gap between the rollers.

18. The system of claim 12, wherein a rotation speed of each roller is decreased from a first roller in the sequence to a last roller in the sequence.

19. The system of claim 12, further comprising a plurality of compartmentalized feeder element or hopper configured to supply more graphite depending on a desired basis weight distribution.

20. The system of claim 12, further comprising multiple embossing rollers, wherein the embossing rollers are configured to emboss the graphite after the graphite is compressed.

21. The system of claim 12, wherein at least one roller comprises a heating unit configured to dry the compressed graphite.
